(19) United States
(12) Patent Application Publication
(10) Pub. No.: US 2010/0089474 A1
(43) Pub. Date: Apr. 15, 2010

(54) System for Introducing an Additive Into a Fluid Conduit

(76) Inventor: Christopher Sheppard, Bozeat (GB)

Correspondence Address: MCDONNELL BOEHNEN HULBERT & BERGHOFF LLP, 300 S. WACKER DRIVE, 32ND FLOOR, CHICAGO, IL, 60606, US

(21) Appl. No.: 12/438,310

(22) PCT Filed: Aug. 17, 2007
(86) PCT No.: PCT/GB2007/003166

§ 371 Date: Nov. 30, 2009

(30) Foreign Application Priority Data
Aug. 21, 2006 (GB) 0616575.7

(51) Int. Cl. F15D 1/00

(52) U.S. Cl. 137/560; 137/565.01; 137/613

(57) ABSTRACT

An additive unit for a central heating or hot water system is connected in line to conduits of the system. The additive unit comprises a chamber having an inlet connected to a first conduit and provided with a valve, and an outlet connected to a second conduit and provided with a valve. The chamber is provided with a drain tap and an access port with a closure cap. A bypass conduit extends through the interior of the chamber. The inlet valve and the outlet valve switch flow from a normal route through the chamber to a bypass route through the bypass conduit. Fluid isolated in the chamber can be removed via a drain tap and an additive/top up fluid introduced via a port. Normal flow can then be restored by operating the valves.

The present invention relates to a system for introducing an additive into a fluid conduit. The invention is particularly, but not exclusively, concerned with introducing an additive into water flowing through a pipe in a central heating and/or hot water supply system.

There is no doubt that both domestic and industrial heating systems can be affected and sometimes even damaged by corrosion and contaminants that flow throughout the system when it is in operation. These contaminants are caused by the continual heating, cooling, subsequent pressure changes and water motion throughout the system infrastructure, when it is in operation. There is plenty of evidence available that proves that these contaminants can cause a whole range of problems within the system infrastructure. In addition, these problems also affect the effectiveness and efficiency of the system, which subsequently causes additional costs in both maintenance and operational fuel costs.

To help eliminate these contaminants, whole ranges of chemical products have been specifically designed that once added to a heating system infrastructure, will help to ensure that its operation is more effective and efficient. The addition of these chemicals has also been proven to increase the reliability of the infrastructure and its components, whilst also helping to prolong its operational life. Once added to the system, these chemicals will drastically reduce the possibility of system failure, system leaks and boiler breakdowns, which in turn, saves considerable money on maintenance, engineering call outs, infrastructure replacement parts and excessive fuel and energy bills to the user.

However, although a vast amount of research and development has been made in producing these additives, it would seem that an effective method of inserting them into the infrastructure has not been developed.

In the past, the simplest method for adding these chemicals into the heating infrastructure has been via the central heating expansion tank. The existence of this expansion tank makes the insertion of any chemical additive reasonably simple. However, although this method is the simplest way to add the additive to the system, it is not an instant fix and nor is it, the most effective way to add the additives quickly, as it may take some time before the water in this tank actually circulates throughout the system.

Due to the continued technological advancement in heating infrastructures, in the future, the open expansion tank will no longer be used in the heating infrastructure. This is because the latest and more efficient heating systems that are now being developed, operate completely sealed from the outside air, in addition they are also pressurised.

However, although the newer and more modern systems are in fact more effective and efficient, their operational efficiency relies totally on the system being free from contaminants and subsequent blockages. This is of paramount importance with pressurised systems, as contaminants and subsequent infrastructure blockages can cause serious and expensive damage to both its infrastructure and the boiler. In addition, such contaminants and blockages will also cause the boiler to operate inefficiently, resulting in bad fuel economy and possible future damage to the boiler.

With the phasing out of the open expansion tank, the only reasonable method to date of inserting the additives is in the process of being totally phased out, it is reasonable to surmise, that unless a new and effective method is found that will carry out this action, even less effort will be made to add these essential additives to modern heating systems in the future. Without an open expansion tank, adding chemical additives to the heating infrastructure becomes extremely awkward and difficult. As the newer systems are sealed, the only way to add any water treatment is by removing, i.e. draining, water from areas of the infrastructure, which is extremely limited, and re-filling with water and the additive, which is extremely fiddly and can be very awkward.

The development of the pressurised system has enabled the heating operation to become much more effective in its operation and considerably more efficient in both central and water heating control. Boiler manufactures and Government Watch Dogs have been aware of the advantages of this type of system for some years especially regarding its efficiency, fuel saving capabilities and most importantly, its reduced air pollution qualities. It is for these reasons that the Government has stipulated specific guidelines to boiler manufacturers, regarding the efficiency of the device in both operation and fuel economy, including the introduction of specific standards concerning the pollutants that the device produces, whilst it is operating.

Figures produced by a number of respected organisations in the domestic and industrial heating fields, believe that within the next 5 years, over 7.5 million new sealed systems will be installed in domestic properties throughout the United Kingdom. In addition, all new builds requiring a heating infrastructure will be supplied with sealed systems, instead of the older, less efficient, open expansion tank type. Over 7.5 million new high efficiency-condensing boilers will be installed in the UK over the next few years. These boilers will be installed either as new installations, or as replacement for older non-condensing versions, which will be no longer supported in the UK.

Because the new system and infrastructure is now completely sealed, there is a problem area concerning effective and efficient methods for adding important chemical additives to the system infrastructure, whilst it is in use. It is also important that the water is monitored at various stages in its operational life, so that it can be determined whether additional treatments have become necessary to keep the system in good and effective condition.

Viewed from one aspect, the present invention provides a fluid circulation system comprising first and second conduit portions which are part of a circulation path for a fluid, and a pump for circulating the fluid around the circulating path, wherein there is provided an additive unit comprising: a chamber having an inlet which is connected to the first conduit portion and an outlet which is connected to the second conduit portion; an inlet valve for selectively permitting fluid flow from the first conduit portion into the chamber, and an outlet valve for selectively permitting fluid flow from the chamber to the second conduit portion; a drain outlet for the chamber, controlled by a drain valve; an access port for introducing fluid into the chamber from an external source, and a closure for the access port.

In use of such a system, with the inlet valve and outlet valves in the shut condition, the chamber is isolated from the circulation path of the fluid. In this condition, the drain valve can be used to drain some or all of any fluid within the chamber. The drain valve is then shut and the additive introduced into the chamber through the access port. The additive may be in dry form and mixed with fluid introduced into the chamber or already there, or the additive may be in liquid form. In any event, care should be taken to ensure that the chamber is full before closing the access port, so that air is excluded. If necessary, additional basic fluid of the type to be circulated can be introduced to ensure that the chamber is full.

Prior to introducing any additive into the chamber, fluid already in the chamber can be tested to check the quality of the fluid. If no additive is needed, the chamber is simply filled up with the basic fluid. Otherwise, the appropriate amount of additive is used as described above.

When the chamber is full, the access port is closed and then the inlet valve and outlet valves are opened. The additive will join the main flow of fluid and over time will mix throughout the system.

In one arrangement, the chamber is an in line part of the circulation path, extending between the first and second conduit portions. In such an arrangement, when the inlet and outlet valves are shut there is no circulation and before shutting the valves the pump would normally be turned off unless there is a way of bypassing that part of the circulation path including the first conduit portion, second conduit portion and the chamber. In an alternative arrangement there is a third conduit portion interconnecting the first and second conduit portions, so that the chamber and the third conduit portion provide parallel paths between the first and second conduit portions. When the inlet and outlet valves are shut, the third conduit provides a bypass route for the circulating fluid sop that the pump can continue to circulate the fluid. In such an arrangement, when the inlet and outlet valves are open there are various possibilities for the available flow paths. One possibility is that both the chamber and the third conduit provide a flow path from the first conduit portion to the second conduit portion. Another possibility is that only the chamber provides a flow path, in which case there could be two way valves that control both access to the chamber and access to the third conduit. In such an arrangement the third conduit is only used as a bypass whilst the chamber is isolated.

Another possibility is that once the additive has been mixed in to the main fluid flow, the inlet valves and outlet valves are closed so that circulation only takes place through the third conduit. In the latter case, if testing is required the valves should be opened for a period so that the fluid in the chamber matches that circulating through the system.

In a preferred arrangement, the third conduit is formed on or in the main part of the additive unit defining the chamber. Alternatively, there could be a separate bypass third conduit.

Preferably the inlet and outlet valves are integral with the main part of the additive unit defining the chamber.

An optional feature is the provision of a viewing window for the chamber, so that the level of fluid within it can be seen. This may be provided with volume gradations so that the quantity of an additive fluid can be measured, or the quantity of the basic fluid drained out or remaining can be measured.

The various components can be made of metals, plastics, glass or any other materials suitable for the operating conditions.

In the environment for which it is primarily intended, the fluid will be water in a central heating system, heated by a boiler, solar panels or other available means. The additive will be formulated to deal with corrosion, water hardness and so forth. However, the system can be used in other contexts and for other liquids and additives.

In general, the chamber will have an interior cross section that is substantially greater than that of the first or second conduit portions, for example having an internal transverse dimension that is at least three times that of the conduit portions, at preferably at least four, five or more times that of the conduit portions. The chamber may be of any desired cross section, such a square, circular or elliptical. In an arrangement with a bypass third conduit, this may pass through the interior of the chamber.

The chamber is preferably elongate, for example being at least generally cylindrical. In use it will normally be positioned with its longitudinal direction upright, and usually generally parallel to the first and second conduit portions. The drain tap will then be at the bottom of the unit, and the access port at the top. The unit may be positioned in any convenient spot, for example close to the boiler of a central heating system. Normally, the inlet will be at one end of the chamber, and the outlet at the other.

Viewed from another aspect the invention provides a method of adding an additive to fluid in a fluid circulation system; the system comprising first and second conduit portions which are part of a circulation path for the fluid, wherein there is provided an additive unit comprising: a chamber having an inlet which is connected to first conduit portion and an outlet which is connected to the second conduit portion; an inlet valve for selectively permitting fluid flow from the first conduit portion into the chamber, and an outlet valve for selectively permitting fluid flow from the chamber to the second conduit portion; a drain outlet for the chamber, controlled by a drain valve; an access port for introducing fluid into the chamber from an external source, and a closure for the access port; wherein the method comprises the steps of closing the inlet and outlet valves, operating the drain valve to drain at least some fluid from within the chamber, closing the drain valve, operating the closure for the access port to gain access to the chamber, introducing additive into the chamber through the access port, ensuring that the access chamber is substantially filled with fluid, closing the access port, and opening the inlet and outlet valves.

Viewed from another aspect the invention provides an additive unit for use in adding an additive to fluid in a fluid circulation system, the additive unit comprising: a chamber, an inlet connected to the chamber and adapted for connection to a first conduit portion, an outlet connected to the chamber and adapted for connection to a second conduit portion; an inlet valve for the inlet, an outlet valve for the outlet; a drain outlet for the chamber, controlled by a drain valve; an access port for introducing fluid into the chamber from an external source, and a closure for the access port.

The additive unit may incorporate a filter to trap contaminant particles in the circulating fluid. In one arrangement, such a filter can be introduced into the chamber through the access port, and removed from the chamber through the access port for cleaning or replacement. Additionally or alternatively there may be a magnet within the chamber, to capture ferrous particles in the fluid. In one arrangement this magnet can be removed from the chamber through the access port to enable captured particles to be cleaned off, and re-introduced into the chamber through the access port.

Additionally or alternatively, there may be a sacrificial anode or cathode within the chamber. If there is also a filter, the anode or cathode may optionally be disposed within the filter or attached to it. If there is also a magnet, the anode or cathode could be attached to it. It could for example be a tablet. The purpose of the anode or cathode is to reduce corrosion, and it could be of any size or shape, and be either loose or fixed in place. Preferably the anode or cathode can be removed from the chamber through the access port, for inspection, maintenance, changing if necessary, and replacement through the port.

The additive unit may incorporate a sensor in the chamber for monitoring the quality of fluid, detecting the levels of chemicals in the fluid, detecting the level of contaminants in the fluid and so forth. The sensor could be of any suitable type, for example optical, electrical, electronic and so forth. The sensor is preferably connected to an electronic module provided on the unit which can process signals from the sensor and can provide readings, warnings which may be visual and/or audible, and so forth. In a preferred arrangement, the module incorporates a communications device which can transmit readings or other information to a remote location, for example by means of a wireless connection such as infra-red, radio, cellular phone network using data or text message communication, Bluetooth (Trade Mark) or the like, or by means of a wired connection such a via a USB port or a network port or any other suitable connection to a computer. There may be the ability to communicate automatically with a remote service location, to set in motion a service call to the location of the unit, in order to inspect the state of the circulating fluid and perform any actions that are necessary.

As noted above the additive unit may be used to take a sample of the fluid to determine whether additive needs to be introduced. If the additive level is acceptable then nothing is added at that stage. In general, the additive unit may be used not just for adding an additive to the fluid, but for sampling the fluid, whether to determine whether remedial action is necessary or to look for signs of anything hazardous, and in some circumstances could be used solely for sampling purpose. This would be of use if, for example, the result of testing was that the system needs to drained of fluid and re-filled. In general though, the unit should have not only a means of taking fluid from the chamber but also a means of introducing fluid back into the chamber so that there will be no air introduced into the system.

Viewed from another aspect of the invention, there is provided a unit for isolating a sample of fluid in a fluid circulation system, the unit comprising: a chamber, a first inlet connected to the chamber and adapted for connection to a first conduit portion, a first outlet connected to the chamber and adapted for connection to a second conduit portion; an inlet valve for the first inlet, an outlet valve for the first outlet; a second outlet for removing a sample of fluid from the chamber; means for selectively opening and closing the second outlet; a second inlet for introducing fluid into the chamber; and means for selectively opening and closing the second inlet.

The second inlet and the second outlet could be provided by a common port.

Viewed from another aspect of the invention, there is provided a unit for isolating a sample of fluid in a fluid circulation system, the unit comprising: a chamber, an inlet connected to the chamber and adapted for connection to a first conduit portion, an outlet connected to the chamber and adapted for connection to a second conduit portion; an inlet valve for the inlet, an outlet valve for the outlet; and a third conduit portion interconnecting the first and second conduit portions, whereby a sample of the circulating fluid can be isolated in the chamber by closing the inlet and outlet valves, whilst circulation of the fluid continues through a bypass route provided by the third conduit portion.

An additive or isolating unit in accordance with the various aspects of the invention may be a stand-alone unit which can be positioned wherever is appropriate and convenient in a fluid circulating system. However, the unit may also be incorporated in another component of a fluid circulating system, for example in the boiler or radiator of a central heating and/or water heating system.

It will be appreciated that there may be variations within the scope of the invention and that some features specified in the various aspects and embodiments of the invention may be omitted. For example, there may be a single route for access to the interior of the chamber, for removing fluid from and introducing fluid into the chamber. In embodiments using a bypass passage, that bypass passage could be provided externally of the unit and / or could be open permanently so that in normal use there are parallel flow paths. The expression “valve” encompasses any suitable means for preventing or permitting fluid flow.

Some embodiments of the invention will now be described by way of example and with reference to the accompanying drawings in which:

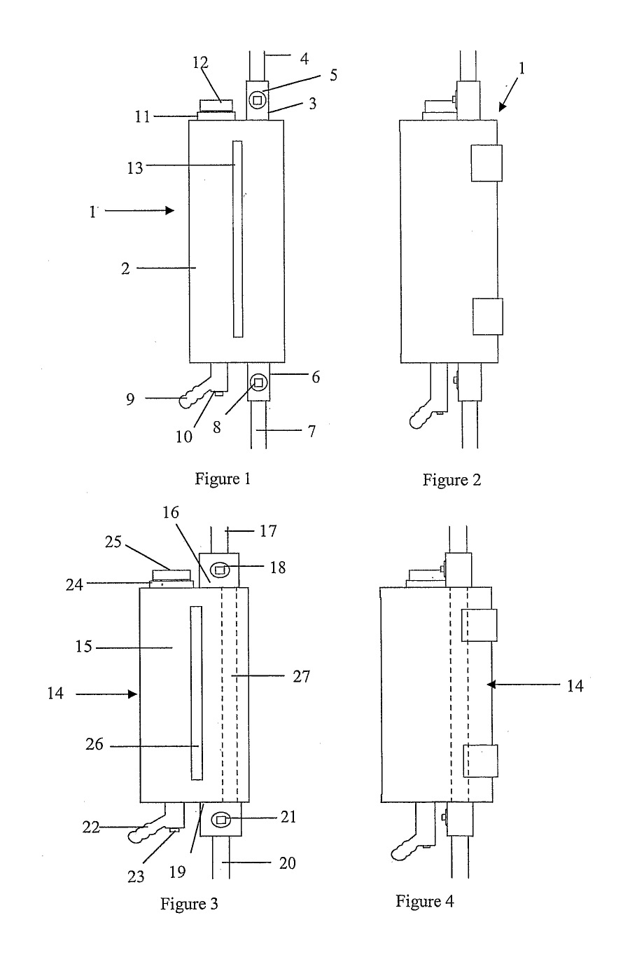

FIG. 1 is a front view of a first embodiment of an additive unit in accordance with the invention;

FIG. 2 is a side view of the additive unit of FIG. 1;,

FIG. 3 is a front view of a second embodiment of an additive unit in accordance with the invention;

FIG. 4 is a side view of the additive unit of FIG. 3;

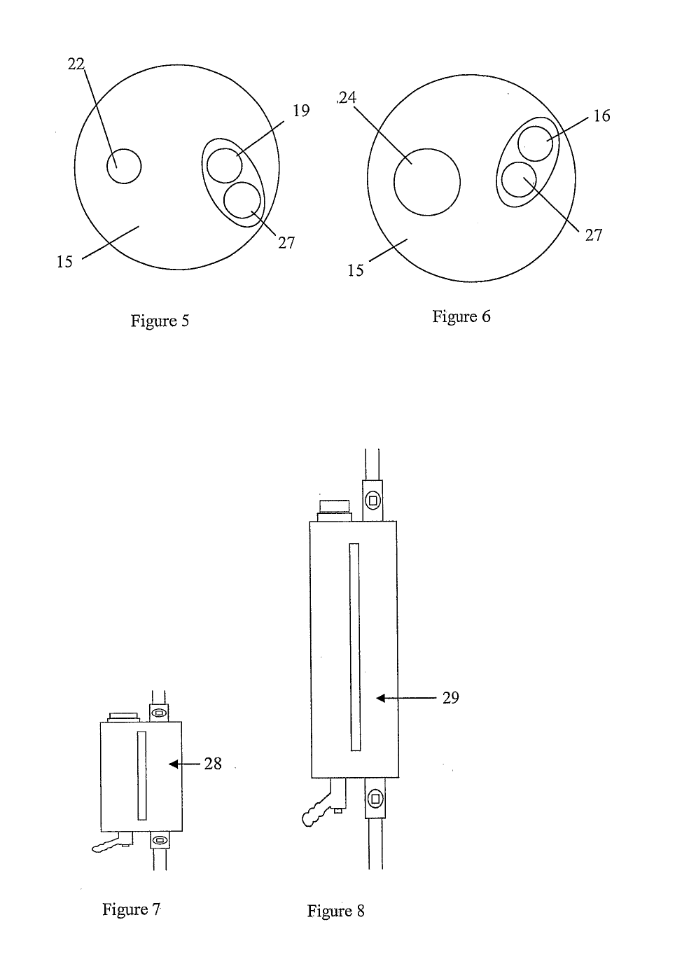

FIG. 5 is a diagrammatic interior view of the base of the additive unit of FIG. 3;

FIG. 6 is a diagrammatic interior view of the top of the additive unit of FIG. 3;

FIG. 7 is a front view of a modification of the first embodiment of the invention;

FIG. 8 is a front view of a further modification of the first embodiment of the invention;

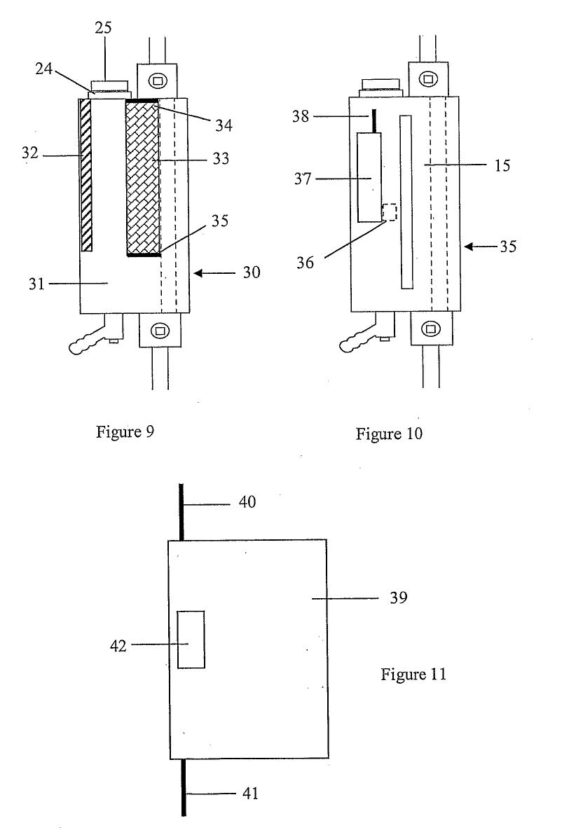

FIG. 9 is diagrammatic view of a modification of the second embodiment of the invention;

FIG. 10 is diagrammatic view of a further modification of the second embodiment of the invention; and

FIG. 11 is a diagrammatic view of a boiler incorporating an additive unit in accordance with the invention.

Referring now in more detail to the drawings, FIGS. 1 and 2 show an additive unit 1 for a domestic central heating system comprising a chamber 2, an inlet 3 for the chamber connected to a first conduit portion 4 and provided with a valve 5, an outlet 6 for the chamber connected to a second conduit portion 7 and provided with a valve 8, a drain tap 9 at the bottom of the chamber with a drain valve 10, and an access port 11 at the top of the chamber provided with a closure cap 12. The chamber is elongate and cylindrical, and its diameter is about five times that of the conduit portions. The chamber is provided with an elongate transparent window 13 extending up its wall, which has gradations (not shown) to indicate volume measurement in both upward and downward directions. A tool (not shown) is provided for operating the valves 5, 8 and 10 and the closure cap 12.

The unit 1 can be installed at any point of the heating infrastructure. However, it is recommended that it be installed, as near to the boiler as possible and on the return feed to the boiler. This position would be the coolest point in the circuit and therefore the most effective place for the device in the heating infrastructure. The unit could be incorporated in the structure of such a boiler.

To use this embodiment of the device, it is first necessary to set the heating system control panel to the OFF position for both hot water and heating, as this will stop the main pump from operating.

Using the tool supplied, the inlet and outlet valves of the unit are closed off. Then, using the same tool supplied, one possibility is to slowly release the closure cap, taking care since the unit will be under a small amount of residual pressure. Once removed, it is the necessary to open the drain valve using the tool supplied and remove the quantity of water required, using the measuring scale that is provided on the unit. Using the same tool the drain valve is then tightened again. In a preferred arrangement, however, the first operation is for the drain valve to be opened as this may be a safer way to release the pressure and provides a safe outlet for excess water and pressure. The closure cap would then be released to allow air into the chamber.

A suitable chemical additive can then be introduced into the unit through the access port. If the additive does not fill the chamber right to the top of the access port, it is necessary to add water to make up the level. The liquid should be level with the top of the closure cap before replacing the cap. This prevents excessive air from entering the system infrastructure once the closure cap has been replaced. The closure cap is then replaced and tightened using the supplied tool.

Using the tool supplied, it is now possible to re-open the outlet valve and then the inlet valve, and to check for any water leakage. The tool can then be replace back in its holder.

The heating and water controls can then be turned back to their operating positions, so that fluid starts circulating again. Checks should be carried out to confirm that the system has reached its operating pressure and to check for leaks etc.

A second embodiment is illustrated in FIGS. 3, 4, 5 and 6. An additive unit 14 for a domestic central heating system comprising a chamber 15, an inlet 16 for the chamber connected to a first conduit portion 17 and provided with a valve 18, an outlet 19 for the chamber connected to a second conduit portion 20 and provided with a valve 21, a drain tap 22 at the bottom of the chamber with a drain valve 23, and an access port 24 at the top of the chamber provided with a closure cap 25. The chamber is elongate and cylindrical, and its diameter is about five times that of the conduit portions. The chamber is provided with an elongate transparent window 26 extending up its wall, which has gradations (not shown) to indicate volume measurement in both upward and downward directions. A tool (not shown) is provided for operating the valves 18, 21 and 23 and the closure cap 25.

This embodiment differs from the first embodiment by the provision of a bypass conduit 27 which extends through the interior of chamber 15 and is connected to the conduit portions 17 and 20. The inlet valve 18 and the outlet valve 21 switch flow from through the first and second conduits and the chamber, in one valve position (for example “Normal”), to through the first and second conduits and the bypass conduit in a second valve position (for example “Bypass”).

The bypass conduit enables the unit to be operated on during normal working conditions, without affecting the flow of water through the system's infrastructure during monitoring, water removal, or installation of any chemicals, or additives etc.

The operation of this embodiment is identical to operation of the first embodiment, except that it is not necessary to stop the pump from operating, and the valves 18 and 21 operate to switch flow to the bypass conduit rather than terminate flow.

The product size and shape can be varied to allow for it to operate in a wide range of system types and spaces. In addition, the design and size can be changed to serve larger systems that require the ability to insert higher volumes of chemicals, or additives, as well as smaller systems. An example of a shortened unit 28 is shown in FIG. 7 and an example of an elongated unit 29 in FIG. 8, these units being otherwise identical to the unit of FIGS. 1 and 2.

FIG. 9 shows a unit 30 which is a modification of the unit 14 of FIGS. 3 to 6, and except as described below the structure and operation of this unit are identical to the unit of FIGS. 3 to 6. There is a modified chamber 31, in which is removably mounted a magnet 32 by suitable mounting means (not shown). The magnet catches ferrous particles that circulate in the fluid. The magnet can be removed and replaced through the access port 24 by removing the cap 25. Also mounted in the chamber 31 is a cylindrical filter 33 for trapping contaminants, sludge and so forth. This is again mounted removably by suitable mounting means (not shown). At its upper end the filter 33 is located in sealing fashion around the inlet 16, as shown at 34. At its lower end the filter is closed off, as shown at 35. Fluid thus enters the filter from the inlet, and passes out radially through filtering material such as a gauze, mesh or the like, into the chamber 31 and then through the outlet 19. The filter 33 is sized so that it can be taken out of the access port 24 for replacement or cleaning. It will be appreciated that in other embodiments, only one of the magnet and filter might be provided. The filter and/or magnet could also be incorporated in the unit of FIGS. 1 and 2. In alternative embodiments, the filter and/or magnet could be integral with the cap 25 for the access port 24. This applies also to any sacrificial anode or cathode that might be provided. If a sacrificial anode or cathode is used, it could be item 32 in place of the magnet.

FIG. 10 shows a unit 35 which is a modification of the unit 14 of FIGS. 3 to 6, and except as described below the structure and operation of this unit are identical to the unit of FIGS. 3 to 6. In this case, a sensor 36 is provided in the chamber 15 to provide data concerning the quality of the fluid, the presence of contaminants, temperature and so forth. This communicates the data to a communications unit 37 on the outside of the chamber, which transmits the data as radio signals via an aerial 38 to a suitable station, such as a modem which will connect to a service company and indicate that a service is due. The communications unit can also have lights or a display panel to indicate the status to a user. These features could be used in conjunction of any of the units in accordance with the invention, including those described above with reference to FIGS. 1 to 9.

FIG. 11 shows in diagrammatic form a boiler 39 for a central heating system, with water pipes 40 and 41 through which water is circulated. Inside the casing of the boiler is mounted an additive unit 42 which is connected in the water circulation path and is in accordance with the invention. The unit may be, for example, a unit as described with reference to FIGS. 1 to 10.

Whilst the unit may be used in many environments, in general it is intended for use in an infrastructure of the type found in a central heating system/domestic/industrial, controlling property/building heating and hot water supply. Such an infrastructure includes complete system pipe work, boiler, pump, all valves, electrical control facilities, programmer, tanks, expansion vessels, emersion and subsequent product additions that are generally connected to the infrastructure.

At least in the preferred embodiments, the invention provides a system that:
1) Provides and enables easy and effective monitoring and sampling of the water within the infrastructure;
2) Allows for extremely easy, quick, simple and clean access to the system infrastructure;
3) Allows for additives or specific chemicals to be added to the infrastructure in a simple, effective and efficient method. This product will considerably speed up the time it would take to effectively enter the system, without the need to drain via radiators, tanks, pipe work, or a main filling valves etc (all very awkward points to access the system, especially while it is under pressure)
4) Allows for accurate amounts of additives to be added ranging from 20 ml to 1000 ml (1 litre), although higher or lower amounts can be specified The product has a viewing panel, which also indicates measured amounts both in an up ward and downward direction. In addition, the removal of water from the system can also be measured, allowing for the correct amount of water to be taken out of the system prior to installing the additive.
5) Allows for the minimum amount of air to enter the system, therefore reducing the necessity for air bleeding.

1. A fluid circulation system comprising first and second conduit portions which are part of a circulation path for a fluid, and a pump for circulating the fluid around the circulating path, wherein there is provided an additive unit comprising: a chamber having an inlet which is connected to first conduit portion and an outlet which is connected to the second conduit portion; an inlet valve for selectively permitting fluid flow from the first conduit portion into the chamber, and an outlet valve for selectively permitting fluid flow from the chamber to the second conduit portion; a drain outlet for the chamber, controlled by a drain valve; an access port for introducing fluid into the chamber from an external source, and a closure for the access port.

2. A system as claimed in claim 1, wherein the inlet and outlet valves are integral with a main part of the additive unit defining the chamber.

3. A system as claimed in claim 1, wherein there is provided a viewing window for the chamber.

4-7. (canceled)

8. A system as claimed in claim 1, wherein the chamber is an upright cylinder and the drain outlet is at the bottom of the chamber and the access port is at the top of the chamber.

9. A system as claimed in claim 1, wherein the chamber is an in line part of the circulation path, extending between the first and second conduit portions, and the inlet and outlet valves have closed positions in which circulation is prevented.

10. A system as claimed in claim 1, wherein there is a third conduit portion interconnecting the first and second conduit portions, the chamber and the third conduit portion providing parallel paths between the first and second conduit portions.

11. A system as claimed in claim 10, wherein the third conduit provides a bypass route for the circulating fluid when the inlet and outlet valves are shut.

12. A system as claimed in claim 11 wherein the inlet and outlet valves switch fluid flow between the chamber and the third conduit.

13. A system as claimed in claim 10, wherein the third conduit passes through the interior of the chamber.

14. A system as claimed in claim 1, which is a heated water system.

15. A system as claimed in claim 14, wherein the additive unit is incorporated in a boiler of the heated water system.

16. A system as claimed in claim 1, wherein the chamber is provided with a filter.

17. A system as claimed in claim 1, wherein the chamber is provided with a magnet to trap contaminant particles.

18. A system as claimed in claim 1, wherein the chamber is provided with a sensor to detect properties of fluid flowing through the chamber.

19. A system as claimed in claim 18, wherein the sensor is connected to a communications unit which transmits data from the sensor to a remote location.

20. (canceled)

21. An additive unit for use in adding an additive to fluid in a fluid circulation system, the additive unit comprising: a chamber, an inlet connected to the chamber and adapted for connection to a first conduit portion, an outlet connected to the chamber and adapted for connection to a second conduit portion; an inlet valve for the inlet, an outlet valve for the outlet; a drain outlet for the chamber, controlled by a drain valve; an access port for introducing fluid into the chamber from an external source, and a closure for the access port.

22-23. (canceled)

24. An additive unit as claimed in claim 21, further comprising a bypass conduit interconnecting the first and second conduit portions, the chamber and the bypass conduit providing parallel paths between the first and second conduit portions.

25. An additive unit as claimed in claim 24, wherein the bypass conduit provides a bypass route for the circulating fluid when the inlet and outlet valves are shut.

26. An additive unit as claimed in claim 25 wherein the inlet and outlet valves switch fluid flow between the chamber and the bypass conduit.

27. An additive unit as claimed in claim 24, wherein the bypass conduit passes through the interior of the chamber.
